(19) United States
(12) Patent Application Publication
(10) Pub. No.: US 2011/0277382 A1
(43) Pub. Date: Nov. 17, 2011

(54) Adjustable stake assembly and method of use

(76) Inventor: Kenneth W. Davis, Bernardsville, NJ (US)

(21) Appl. No.: 12/800,501

(22) Filed: May 17, 2010

(51) Int. Cl. A01G 9/12; A01G 9/00

(52) U.S. Cl. 47/70; 47/47; 47/58.1 R

(57) ABSTRACT

An adjustable stake assembly has a stake support appointed to receive at least one stake segment to form a structure, such as a plant support, lattice, fence, plant holder, recreational or decorative structure. The adjustable stake assembly includes a universal stake support having a tip appointed to penetrate a surface, a body portion and a top plate having a protrusion with a stake aperture integrated therein. At least one stake segment having a central portion and a lateral and distal end is appointed to be removably snapped-onto the universal stake support. The stake segment includes a flange appointed to be received in the stake aperture of the universal stake support, and the distal end having a segment aperture integrated therein appointed for receiving another stake segment for vertically stacking a plurality of the stake segments. In another embodiment the stake segments include at least one lateral connector section appointed for receiving at least one lateral connector section of another stake segment for cross-connection of the stake segments in relation to one another. Advantageously, in this manner the stake segments can be interconnected to one another for horizontal cross-connection in forming lattices, fences, or other structures.

### BACKGROUND OF THE INVENTION

1. Field of the Invention

The present invention relates to an adjustable stake assembly and method of use; and more particularly, to an adjustable stake assembly that can readily be snapped together on the vertical and horizontal planes to not only offer height adjustment, but to also offer horizontal cross-wise adjustment for forming lattice, fences, barriers, or a plethora of structures.

2. Description of the Prior Art

Sprawling plants growing upwardly oftentimes require a vertical support. Examples of sprawling plants where vertical supports are commonly implemented include tomatoes, peas, cucumbers, flowers, etc., and vine type plants. Currently stakes are offered as one size. However, where the plant height extends the stake height, the stake must be replaced with a bigger stake. Storage of large or tall stakes can become cumbersome. Moreover, various fencing and plant coverings are required to protect plants while they are growing in order to facilitate proper growth.

Several approaches devised by prior art workers attempt to provide solutions for providing vertical support for climbing plants. These approaches include 1) use of stakes; 2) use of stakes which include expansion and bisecting rods; or 3) expansion stakes that accommodate height growth. None of these solutions suggests an adjustable stake assembly that can readily be snapped together on the vertical and horizontal planes to not only offer height adjustment, but to also offer horizontal adjustment, as well as the ability to form fences and other barriers or structures to protect plants during growth.

U.S. Pat. No. 4,610,107 to Testa discloses an improved vine trainer, which is assembled and disassembled to become portable in kit form. A central stake is provided that is comprised of a plurality of interconnected sections. A number of rods, shorter in length than the central stake, are stacked and crossed with each rod bisecting the others and are removably affixed to the upper portion of the central stake. The rods are formed with openings on each end for receiving twine, wire, or the like, and secured to ground stakes which are inserted into the earth or potting soil of a potted plant, providing a substantially vertical and rigid surface on which plant vines can grow.

U.S. Pat. No. 5,640,802 to Elliott discloses a support assembly for growing tomato plants during the various stages of growth by utilizing interchangeable parts including post sections having a tapered member (A) on a bottom end and a tapered socket (B) on the other end for joining the sections to form continuous posts having vertically spaced seating locations (C), and horizontal supports (D) having sockets (E) which fit securely onto post sections and are spaced vertically to form modules that may be stacked in vertical relation and thereby added progressively to meet the needs engendered by growth of the plant and to permit ready access to the plant.

U.S. Pat. No. 6,922,942 to Stefanutti discloses a vine wire support post molded as integral unit from plastics with an elongate tapered supporting portion having upper end and lower end, a wire attachment provided on the supporting portion, a peg for holding support post in ground joined to lower end of supporting portion, a foot at the join between peg and supporting portion. The supporting portion is flexible and has variable sectional strength decreasing over a length of supporting portion from a position of higher sectional strength nearer the lower end to a position of lower sectional strength nearer the upper end.

U.S. Pat. No. 7,004,403 to Thayer et al. discloses an irrigation spray stake for plants grown in pots utilizing an elongated stake member having an upper extremity and a lower extremity adapted to be inserted into the soil, with a spray head adjacent the upper extremity of the stake member, with an arrow or similar feature along the stake member between the upper and lower extremities to indicate the predetermined spraying direction of the spray head. The arrow or similar feature may be formed as a plate which rests against the surface of the soil, with the back edge of the plate resting against the inner surface of the nursery pot into which the stake is extended.

U.S. Patent App. Pub. No. 2008/0190019 to Hart discloses a plant support system having a central post, at least first and second cross pieces, and a plurality of strings. The central post has a first end disposed in the ground and an opposite second end. The cross pieces extend outwardly from the central post second end. Each of the cross pieces has a first end releasably securable to the central post second end and a second distal end. Each of the strings is securable to a corresponding one of the cross pieces. A plant growing proximate the central post is attachable to a corresponding one of the strings as the plant grows upwardly. The present invention also relates to a method of supporting growing plants.

U.S. Patent App. Pub. No. 2008/0209802 to Williams discloses a gardening stake kit for plant training including a plurality of shaft segments that are connectable end to end to form a shaft of variable lengths. A plurality of grooves or protrusions is formed in or on an outer periphery of each shaft segment. A pointed base is connectable to one end of a shaft segment, and a plurality of arms that are connectable to the grooves or protrusions formed in each shaft segment. Preferably, the grooves or protrusions are formed at more than one angle relative to the top and bottom of each shaft segment and; preferably, include horizontal grooves or protrusions as well as angular grooves.

U.S. Patent App. Pub. No. 2009/0077879 to Lisciotti et al. discloses a telescoping pole for supporting growing plants, which comprises two or more elongate pole members, one of which has a pointed stake section at one end to facilitate insertion into the ground. The pole includes means for locking the elongate pole members in a number of different telescoped positions, whereby to allow for adjustment of the effective length of the pole according to the height of the plant that it supports. The telescoping members are made of a polymer material, with at least one of the telescoping members comprising two injection-molded component parts that are mechanically attached to one another.

U.S. Patent App. Pub. No. 2010/0005714 to Aiken discloses an apparatus for supporting plants growing from the ground includes an elongated rigid pole with a plurality of axially-spaced apertures along much of the pole. Flexible cord ties are threaded in a spiral fashion through at least three apertures in the long wall of the elongated pole, and knots at the ends are tied around plant stems or branches thereby preventing disengagement from the holes and simultaneously supporting the plant. One end of the elongated pole is cut at an angle to the axis to form a point.

Foreign Pub. No. DE 3,312,130 to Mez discloses a plant stake of the helically coiled type made of iron is to be capable of easily being stably anchored in the earth. To this end, according to FIG. 2, a ground anchor is provided, which has the form of an arrowhead with radially projecting ribs. The shaft of the plant stake is inserted into an axial bore. The ground anchor can, with small penetration depth into the earth, adequately support the plant stake. Use in private and industrial horticulture as well as in pot plants.

Foreign Pub. No. FR 2,758,044 to Benfeghoul discloses a plant stake formed as a post, which is hollow, with an open end at its upper part and closed at its lower extremity, which is designed to be inserted into the ground. The post is fitted with a pipe, which is fitted towards the bottom of the post and is designed to lead the liquid to the base of the plant to be irrigated. The pipe is fitted with a flow control device, which allows the liquid, held in the post to be drip fed to irrigate the plant. The flow can be uniformly regulated or can be fed by a manually adjusted device. The post is designed to support plants or support wires in the normal way, by means of a series of holes (4) in the side flange of the post.

Foreign Pub. No. FR 2,914,339 to Hildbrand discloses a multiuse stud for supporting branches of fruit tree, has parallelepiped section tubes stacked with each other until attaining required height, and spring serving as resilient suspension to upper element of stud. The stud has rectangular or parallelepiped section tubes (1) stacked with each other until attaining required height, where each tube is maintained at the requited height with respect to the other tube by a pin (3). The pin penetrates in an opening corresponding to an opening formed in a receiver tube. A metallic yoke (4) penetrates in an upper tubular of the stud, and a spring (5) serves as resilient suspension to an upper element of the stud. A support of a tree branch comprises a cylindrical metallic element with V shaped lower surface that is covered by rubber or plastic.

Foreign Pub. No. GB 2,309,878 to Bishop discloses a plant support rod that comprises first 114a and second 214a section. Each section has upper and lower opposed end portions, the first section 114a having a terminal part 116 at its lower end and being releasably connectable at its upper end to the second section 214a. Additional sections can be added as the plant grows, of the same or of a different length to that of the first and/or second sections. Also disclosed is an assembly of the first and second sections, the sections lying side by side and held by a transparent plastics envelope.

Foreign Pub. No. GB 2,359,722 to Mclean discloses a device for the support, training and containment of plants, which includes positive attachment point's along the length of the device and incorporates a finther attachment eye at the top of the stake.

Various border columns with metal posts have been provided. One such structure can be found at kinsmangarden.com, which discloses a border column kit having a metal post including an eighteen inch ground spike, a three foot black metal tubular column and a nine inch plate with gripping clips for receiving a basket. Another structure can be found at whieflowerfarm.com/tomato.com which discloses a support for tomatoes having a cage that folds for storage, and discloses red plant ladders having seven v-shaped cross-braces and thirteen inch legs for supporting plants. A Stackable Joint 2-Pack is disclosed at farmtek.com that includes a pair of stacking joints and a finishing sleeve for forming a raised bed, sandbox, water garden, landscape borders, ice skating rings and more.

Notwithstanding the efforts of prior art workers to construct adjustable stake assemblies and the like, there remains a need in the art for an adjustable stake assembly that can readily be snapped together on the vertical and horizontal planes to not only offer height adjustment, but to also offer horizontal climbing adjustment. There is a further need in the art for an adjustable stake assembly that also can be snapped together to form fences and other barriers or structures to protect plants during growth. Additionally, there is a need in the art for an adjustable stake assembly having a plethora of separate applications for decoration and recreation to form flower pot holders, hold netting flit sporting activities, and/or form poles or flag pole holders.

### SUMMARY OF THE INVENTION

The present invention provides an adjustable stake assembly that can readily be snapped together on the vertical and horizontal planes to not only offer height adjustment, but to also offer horizontal climbing adjustment as well as forming lattice and fence type structures. The adjustable stake assembly can be snapped together to form a plethora of structures such as plant supports, fences and other barriers or structures to protect plants during growth. Advantageously, the adjustable stake assembly has a plethora of separate applications for decoration and recreation to form flower pot holders, hold netting for sporting activities, and/or form poles or flag pole holders.

The adjustable stake assembly has a stake support appointed to receive at least one stake segment to form a structure, such as a plant support, lattice, fence, plant holder, recreational or decorative structure. The adjustable stake assembly includes a universal stake support having a tip appointed to penetrate a surface, a body portion and a top plate having a protrusion with a stake aperture integrated therein. At least one stake segment having a central portion and a lateral and distal end is appointed to be removably snapped-onto the universal stake support. The stake segment includes a flange appointed to be received in the stake aperture of the universal stake support, and the distal end having a segment aperture integrated therein appointed for receiving another stake segment for vertically stacking a plurality of the stake segments.

In another embodiment the stake segments include at least one lateral connector section appointed for receiving at least one lateral connector section of another stake segment for cross-connection of the stake segments in relation to one another. Advantageously, in this manner the stake segments can be interconnected to one another for horizontal cross-connection in forming lattices, fences, or other structures.

A method of using an adjustable stake assembly is also provided. The method involves the first step of selecting a universal stake support. The universal stake support includes a tip appointed to penetrate a surface, a body portion and a top plate having a protrusion with a stake aperture integrated therein. The second broad step involves inserting the universal stake support into the surface, i.e. the ground. Lastly, at least one stake segment is attached onto the universal stake support. The stake segment includes a central portion and a lateral and distal end, the lateral end having a flange appointed to be received in the stake aperture of the universal stake support. The distal end includes a segment aperture integrated therein appointed for receiving another stake segment for vertically stacking a plurality of the stake segments.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1a is a schematic view of a first embodiment of the adjustable stake assembly;

FIG. 1b is a view of the embodiment of FIG. 1a showing a single adjustable stake assembly supporting a tomato plant;

FIG. 2 is a schematic view of the first embodiment of the adjustable stake assembly erected with a lattice/fencing insert to form a lattice/fence;

FIG. 3a is a schematic view of another embodiment of the adjustable stake assembly wherein the central portion of the stake segment comprises at least one lateral connector section, herein shown as two lateral connector sections, appointed for receiving lateral connector sections of other stake segments for cross-wise connection of the stake segments in relation to one another and in relation to universal stake supports;

FIG. 3b is a view of the embodiment of FIG. 3a being snapped together to form a support;

FIG. 4a is a view of the embodiment of FIG. 3a snapped together to form a fence or lattice structure that may be used for a plethora of operations, including as a plant lattice, fencing around an area, or to create a gate type structure;

FIG. 4b is a view of the embodiment of FIG. 3a snapped together to form a fence or lattice structure in another configuration that may be used for a plethora of operations, including as a plant lattice, fencing around an area, or to create a gate type structure;

FIG. 4c is a view of the embodiment of FIG. 3a snapped together to form a lattice structure in another configuration such as for holding hanging baskets or the like;

FIG. 4d is a view of the embodiment of FIG. 3a showing a single adjustable stake assembly supporting a tomato plant;

FIG. 5 is a view of the adjustable stake assembly being configured to hold a fence attachment for landscaping plants;

FIG. 6 is a view of the adjustable stake assembly being configured to hold a cross-link fence attachment for keeping pests out of a garden;

FIG. 7 is a view of the adjustable stake assembly being configured to hold a plate attachment for forming a plant holder;

FIG. 8 is a view of the adjustable stake assembly being utilized to hold a tarp or plastic in a garden;

FIG. 9 is a view of the adjustable stake assembly being configured to hold a net attachment for forming a recreational net for volleyball or bad mitten, or the like; and

FIG. 10 is a view of the adjustable stake assembly being configured to hold a flag attachment for forming a flag pole or decorative assembly.

### DETAILED DESCRIPTION OF THE INVENTION

The present invention provides an adjustable stake assembly having a stake support appointed to receive at least one stake segment to form a structure, such as a plant support, lattice, fence, plant holder, recreational or decorative structure. The adjustable stake assembly includes a universal stake support having a tip appointed to penetrate a surface, a body portion and a top plate having a protrusion with a stake aperture integrated therein. At least one stake segment having a central portion and a lateral and distal end is appointed to be removably snapped-onto the universal stake support. The stake segment includes a flange appointed to be received in the stake aperture of the universal stake support, and the distal end having a segment aperture integrated therein appointed for receiving another stake segment for vertically stacking a plurality of the stake segments. In another embodiment the stake segments include at least one lateral connector section appointed for receiving at least one lateral connector section of another stake segment for cross-connection of the stake segments in relation to one another. Advantageously, in this manner the stake segments can be interconnected to one another for horizontal cross-connection in forming lattices, fences, or other structures.

Vine type plants and upwardly growing plant require vertical support. Such plants include tomatoes, peas, cucumbers, flowers, etc., and vine type plants. Currently stakes are offered as one size. However, where the plant height extends the stake height, the stake must be replaced with a bigger stake. What is more, storage of large or tall stakes can become cumbersome. Advantageously, the adjustable stake assembly herein provides the ability to simply extend the vertical height and/or horizontal width of the stake by adding segments thereto. As a result, as the plant grows the adjustable stake assembly does not need to be replaced out. Rather, a segment is simply added to the stake to increase its height or horizontal width. What is more, the adjustable stake assembly can be taken apart for compact storage and shipping and further segments can be purchased for adding onto an existing starter kit. That is to say, the adjustable stake assembly may be provided as a kit having a few, five or six, universal stake supports and a plurality, ten or twenty, of stake segments. If the user desires to build a larger structure than the kit can accommodate, the user can simply purchase additional stake segments and/or additional universal stake supports.

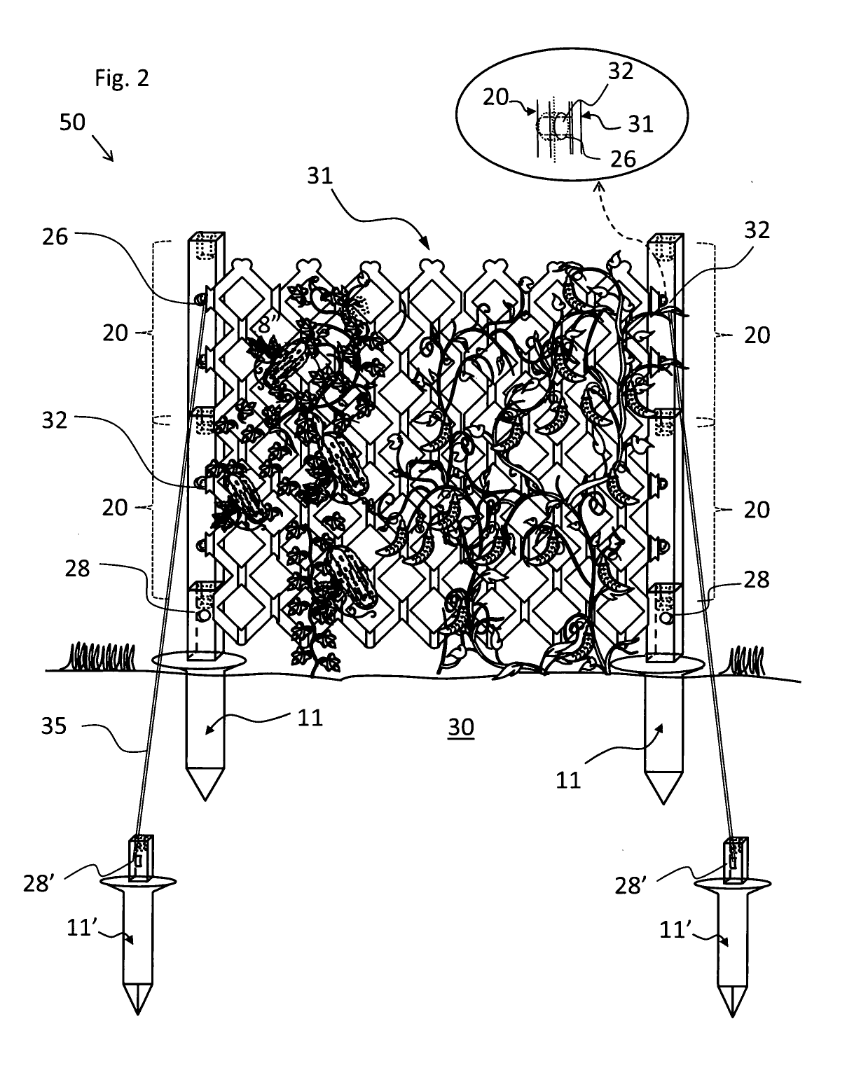

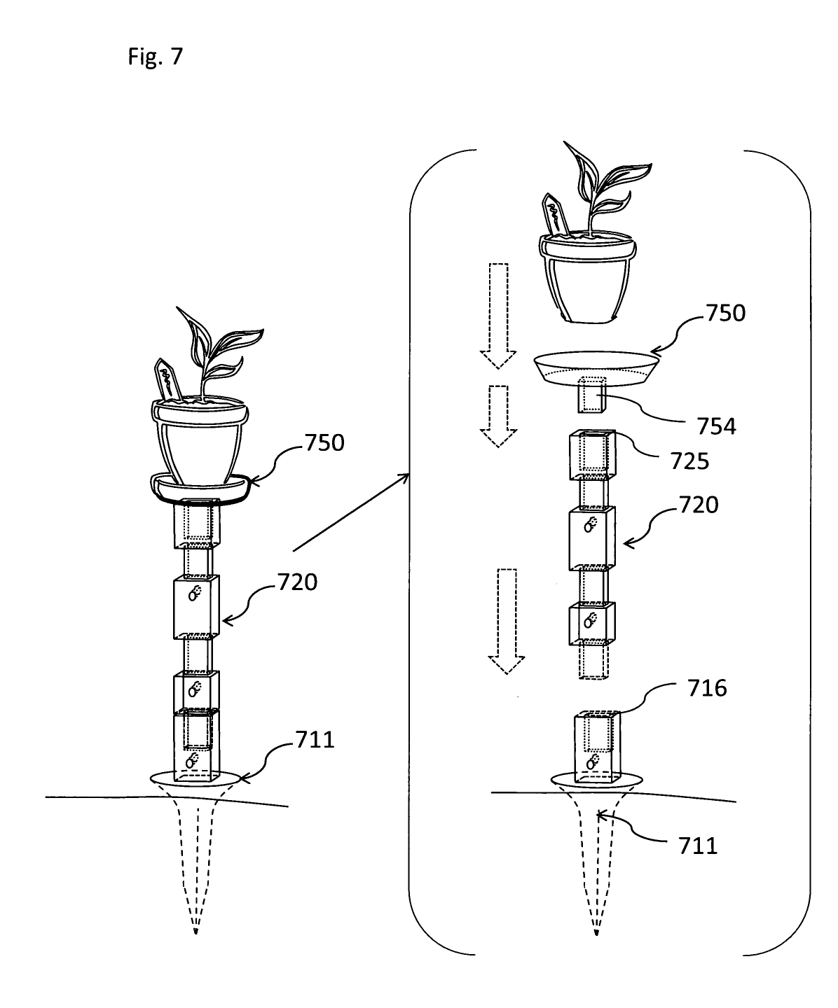

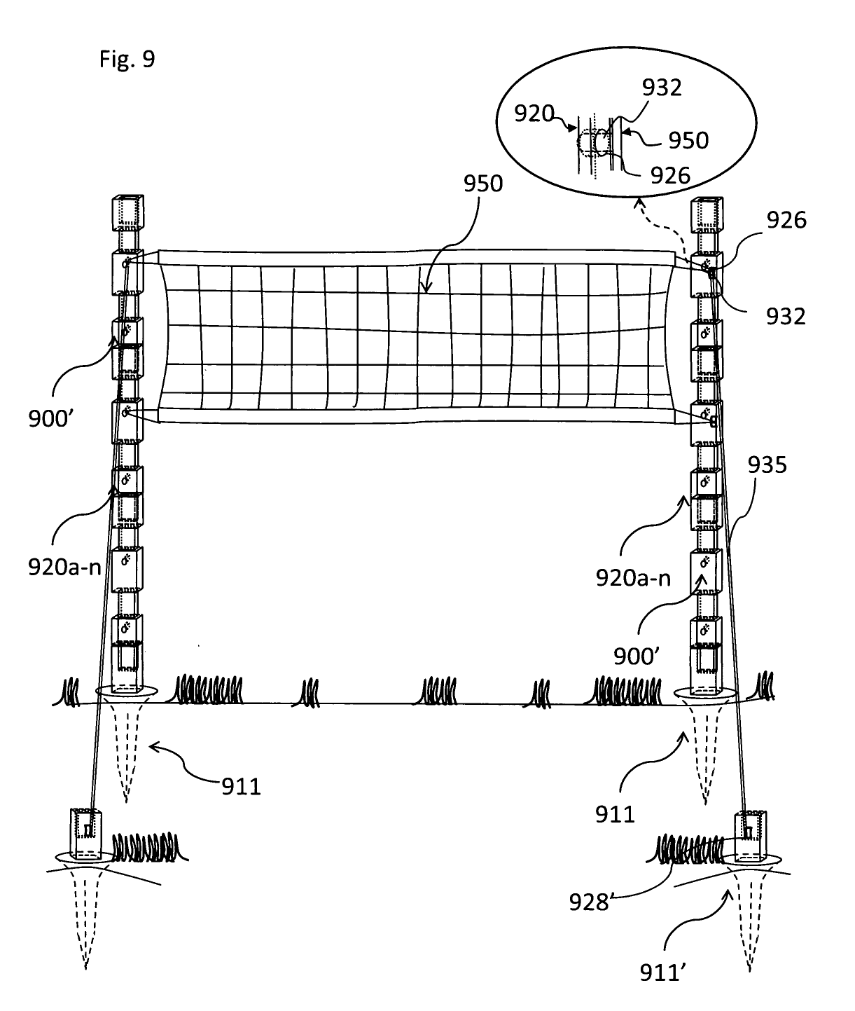

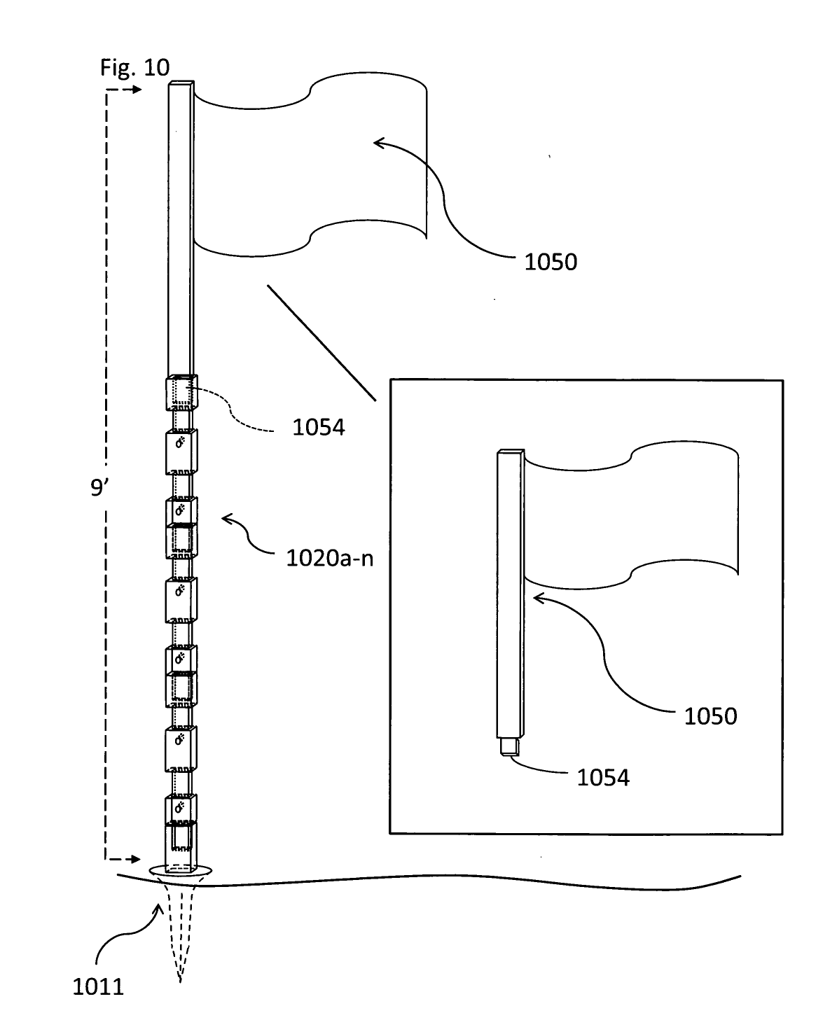

Various add-on devices are provided that can readily snap-fit with the adjustable stake assembly. For example, a plate attachment (i.e. see FIG. 7) is provided that can readily be snapped-onto the assembly to provide a plant holder or small outdoor end table. This affords a user a quick fix to provide a plant holder or small cocktail end table to a patio or lawn area. Other add-ons offered by the assembly herein include recreational netting that can be readily attached to the assembly to form a volleyball or bad mitten game court (i.e. see FIG. 9). The net may be sold as a part of the adjustable assembly kit, or may be a separate net that can simply be attached to the assembly by way of cable tie (zip tie), straps including hook and loop fastener sections (such as that commonly sold under the trade name VELCRO), or rope. Further add-ons include fencing portions, lattices, gardening borders, and flags (i.e. see FIGS. 2, 5, 6, 10).

In use the universal stake support is pressed into the ground by stepping on the side projection/top plate of the support. A plurality of segments which fit into each other are applied to extend the assembly vertically and/or horizontally to extend the stake as plants/tomatoes grow. The use of segments facilitates shipping of the stake components in smaller containers. The stake assembly can be made of injection molded plastic. It can also be made from wood or metal (preferably aluminum).

The adjustable stake assembly can be used as a quick strong support for plants that climb six or seven feet, such as snow peas, cucumbers, tomatoes, etc. In a second embodiment the extension pieces/stake segments are notched in at least one place, preferably at least two places, to form lateral connector sections appointed for receiving corresponding lateral connector sections of other stake segments for cross-wise connection on the horizontal plane. The extension pieces/stake segments are thereby not only used to lengthen the base/universal support stake on the vertical plane, but also are used to expand the assembly for width expansion on the horizontal plane. The segments are used like Lego® type interconnected cross pieces which can be used to form a variety of configurations. In this manner, the adjustable stake assembly becomes a system of interconnected supports and segments that can be used for hanging plants, forming lattice work for climbing plants, to form fence structures or gates. The segment's configuration allows the segments/extension pieces to be extended both vertically and horizontally in a variety of schemes advantageously presenting versatility to the user.

Preferably each of the universal stake supports and the stake segments include at least one support hole. The support hole is a hole that transverses through each of the supports and/or segments and provides the ability for the insertion of a string or rope within the hole for tying up plants or vines so secure same against the adjustment assembly as the plant grows. The support holes may also be used to tie such things as nets, chain link fencing, plastic fencing, mesh fencing, rope fencing or the like, to the erected adjustment assembly. What is more, the universal stake support and stake segments may include at least one fastener means, such as a hook or a latch that is appointed to hold landscape tracts, boarder fencing, ties, ropes, nets, chain link fencing, plastic fencing, mesh fencing, rope fencing or the like, to the erected adjustment assembly.

The universal stake support preferably has a height of twelve (12″) to thirty-two (32″) inches in height. Most preferably the universal stake support is twenty-four (24″) inches in height. The top plate of the universal stake support preferably is disc shaped and has a diameter ranging from 8 to 12 inches. Preferably the protrusion located on the top plate is located at a center point on the top plate of the universal stake support so that the protrusion (1.5″) is located four (4″) to five (5″) inches from the edge of the top plate to provide spacing for a user's foot to fit for pressing the support spike into the ground for a secure fit. Preferably each of the stake segments/extensions has a height ranging in twelve (12″) to twenty (20″) inches—and most preferably have a height of eighteen (18″) inches. This size and height structure of the universal stake and stake segments provide functional advantageous to the assembly. Accordingly, the height of the universal support enables the support to provide optimal structural support for holding up the attached stake segments/extension so that the assembly does not topple over and provides durable, reliable structural support to the assembly and the climbing plant. Moreover, the height range of the universal stake support provides the ability to use the support alone as spikes or the like in forming shallow fences or landscaping boards as well as in use in stabilizing and securing plastic mulch, plastic or tarps in gardens or flower beds. The diameter of the top plate and location of the protrusion on the top plate allows the user to utilized the top plate as a foot support allowing maximum downward force for the insertion of the stake into the ground—therefore the distance between the edge of the top plate and the protrusion should be at least four (4″) to five (5″) inches. The height/length of the stake segments provides the ability to adequately add height to the assembly while not compromising the structural durability and integrity of the assembly's erected structure.

In an embodiment of the stake segments the segment's central portion is constructed having at least one notch/lateral connector section appointed for receiving at least one lateral connector section of another stake segment for cross-wise connection of the stake segments in relation to one another. Preferably, at least two notches/lateral connector sections are provided, each being appointed to receive at least one lateral connector section of two other stake segments for cross-wise lattice connection of the stake segments in relation to one another. The notches/lateral connector sections of the central portion of the stake segment is constructed having a major portion abutting a minor portion, wherein the minor portion has a smaller size than the major portion forming the lateral connector section. Wherein the central portion of the stake segment is constructed having two notches/lateral connector sections there is a major portion abutting two minor portions on either side thereof, wherein the minor portions have a smaller size than the major portion forming at least two the lateral connector sections. In this formation, the stake segments can readily snap onto one another to form a plethora of structures.

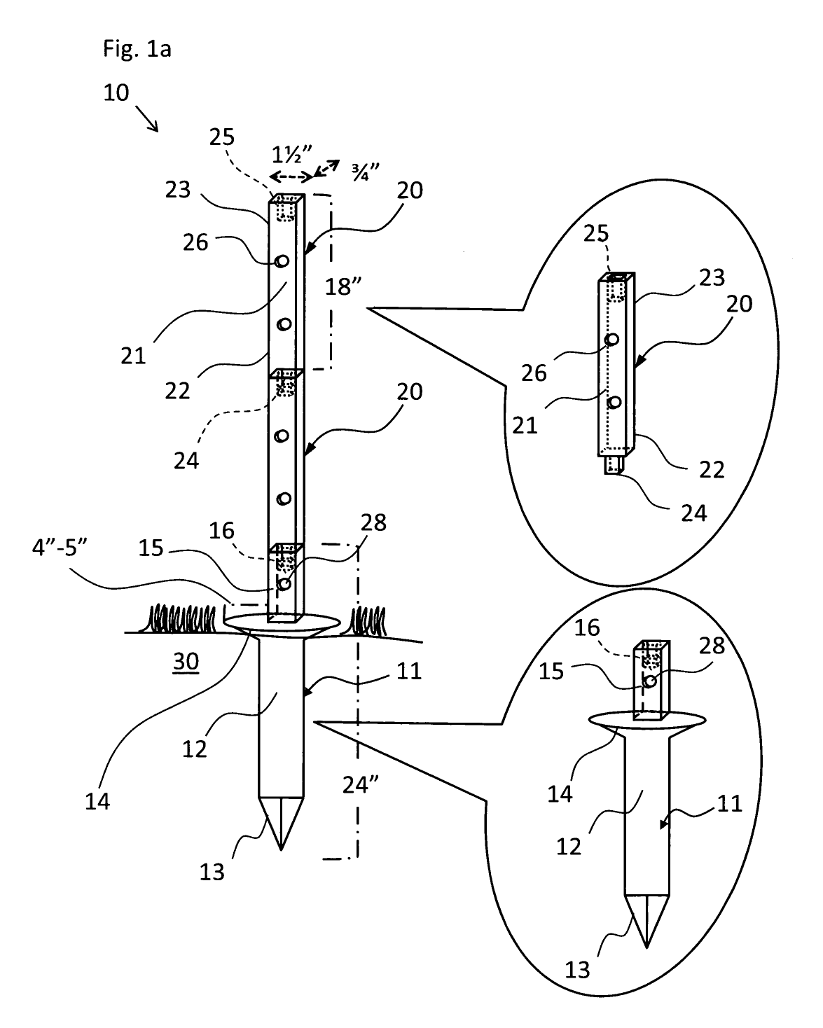

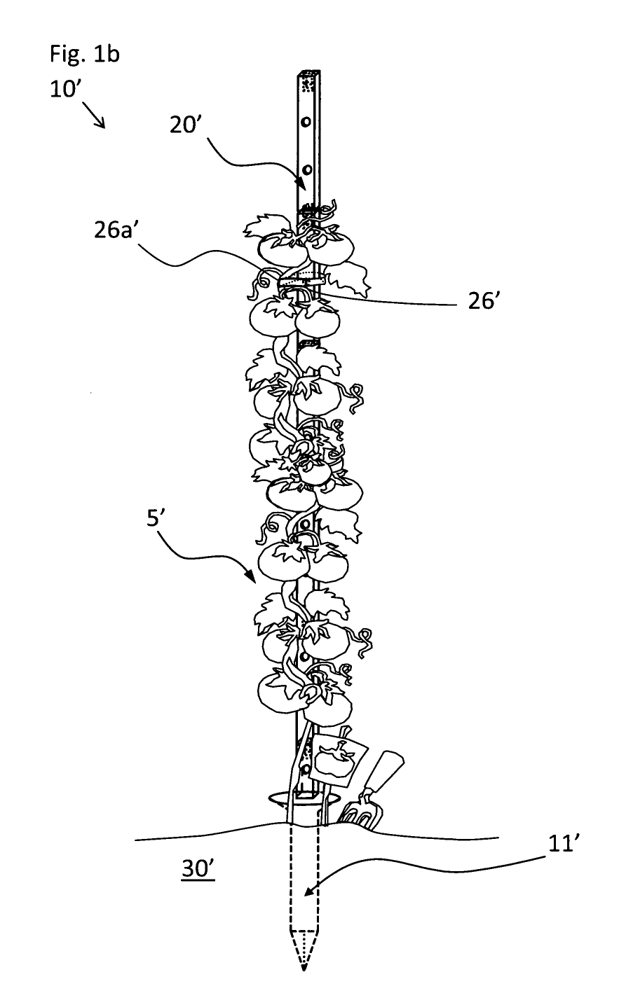

FIG. 1a is a schematic view of a first embodiment of the adjustable stake assembly, shown generally at 10. In the embodiment shown, the adjustable stake assembly is constructed having a universal stake support 11 and at least one stake segment 20, herein shown having two stake segments 20 attached thereto. Universal stake support 11 comprises a tip 13 appointed to penetrate a surface (herein, ground 30), a body portion 12 and a top plate 14 having a protrusion 15 with a stake aperture 16 integrated therein. At least one stake segment 20 having a central portion 21, a lateral end 22 and distal end 23 is provided. Lateral end 22 includes a flange 24 appointed to be received in the stake aperture 16 of the universal stake support 11. Distal end 23 includes a segment aperture 25 integrated therein appointed for receiving another stake segment 20 for vertically stacking a plurality of the stake segments 20a-n to extend the height of the assembly 10. Stake segment 20 additionally includes a plurality of support holes/apertures 26 to tie tomatoes to the stake segment 20. Universal stake support 11 may also include support hole/aperture 28 for insertion of ties or the like. In use the adjustable stake assembly can be pressed into the ground by stepping on the side projection/top plate 14. Optionally, the adjustable stake assembly can comprise a plurality of segments 20 which fit into each other to extend the stake as tomatoes grow. The use of segments 20 facilitates shipping of the stake components in smaller containers. The stake assembly 10 can be made of injection molded plastic. It can also be made from wood or metal (preferably aluminum).

FIG. 1b is a view of the embodiment of FIG. 1a showing a single adjustable stake assembly 10′ with the universal stake support 11′ inserted into the ground 30′ and stake segments 20′ stacked height wise as needed depending on the growth of a tomato plant 5′. Ties 26a′ may be utilized by simply wrapping around stake segments 20′ or by way of insertion through support holes/apertures 26′ to tie the tomato plant 5′ to the stake segment 20′.

FIG. 2 is a schematic view of the first embodiment of the adjustable stake assembly erected with a lattice/fencing insert to form a lattice/fence, shown generally at 50. In the configuration shown, adjustable stake assembly is constructed having a universal stake support 11 with stake segments 20 snapped thereon as discussed in relation to FIG. 1a-1b. A lattice 31 is attached to each of the stake segments 20 and preferably the universal stake supports 11. Attachment may be facilitated in a number of ways. In one embodiment, the lattice 31 is attached via rope, string, cable zip tie, or the like simply wrapped around each of the stake segments 20 and preferably the universal stake supports 11 for securing. In another embodiment, attachment may be facilitated by attached via rope, string, cable zip tie, or the like simply by inserting same in the apertures 26, 28 of each of the stake segments 20 and universal stake supports 11 for securing. In yet another embodiment, the lattice 31 may include snap-knobs 32 that align with and snap into each of the apertures 26, 28 of each of the stake segments 20 and universal stake supports 11. Additional universal stake supports 11′ may be provided wherein a rope 35 extends from the assembly to the universal stake supports 11′ and attached thereto by way of support hole/aperture 28′ for adding support to the structure.

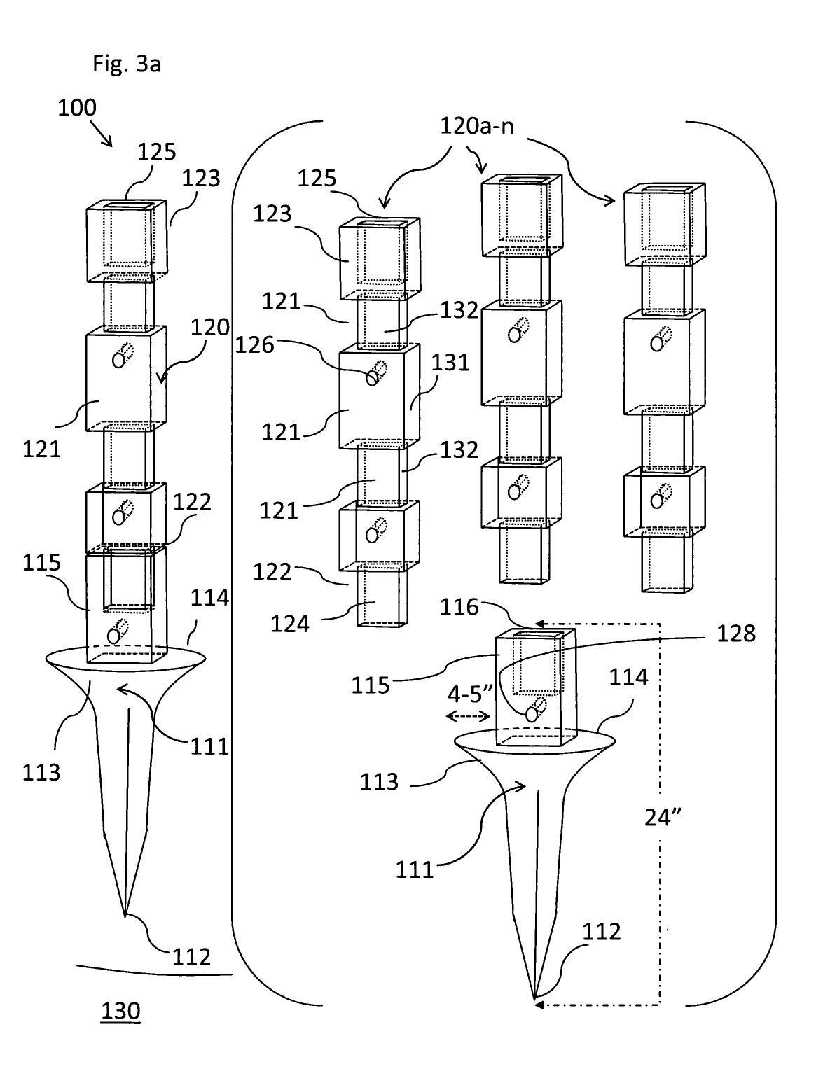

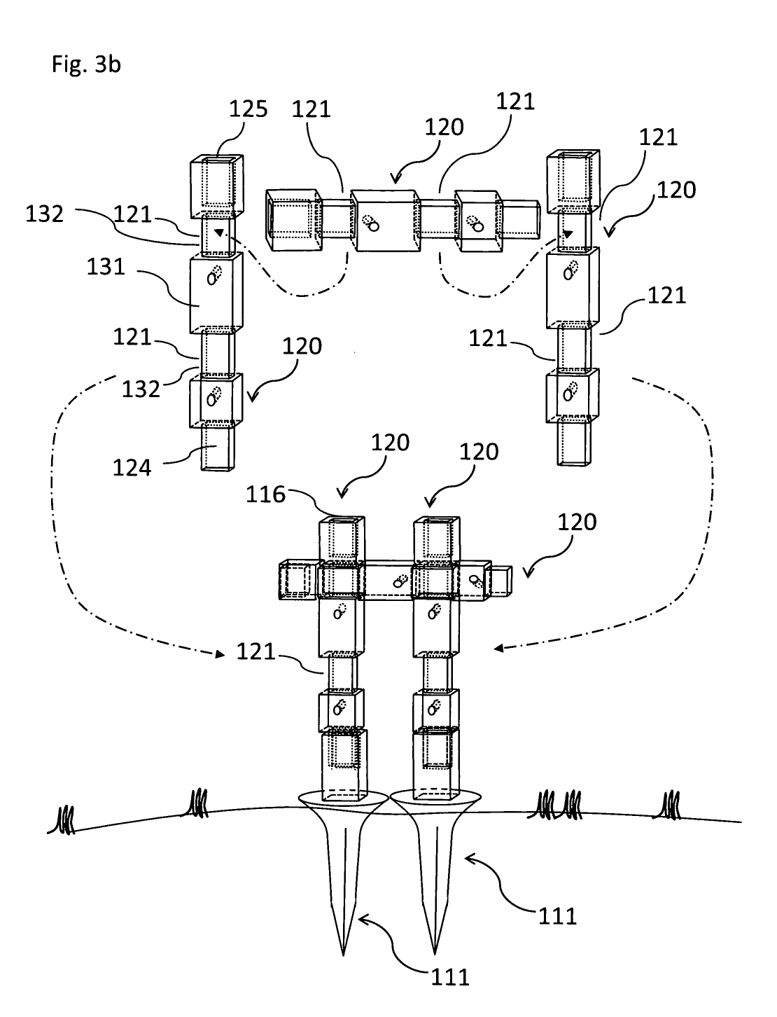

FIG. 3a is a schematic view of another embodiment of the adjustable stake assembly wherein the central portion of the stake segment comprises at least one lateral connector section, shown generally at 100. FIG. 3b shows the snap attachment of the segments. Herein shown, two lateral connector sections are provided, appointed for receiving lateral connector sections of other stake segments for cross-wise connection of the stake segments in relation to one another and in relation to universal stake supports. The adjustable stake assembly 100 includes a universal stake support 111 having a tip 112 appointed to penetrate a surface 130, a body portion 113 and a top plate 114 having a protrusion 115 with a stake aperture 116 integrated therein. At least one stake segment 120 having a central portion 121 and a lateral end 122 and distal end 123 is provided. The lateral end 122 includes a flange 124 appointed to be received in the stake aperture 116 of the universal stake support 111. The distal end 123 includes a segment aperture 125 integrated therein appointed for receiving another stake segment 120 for vertically stacking a plurality of the stake segments 120a-n. Stake segment 120 additionally includes a plurality of support holes/apertures 126 to tie tomatoes/plants/etc. to the stake segment 120. Universal stake support 111 may also include support hole/aperture 128 for insertion of ties or the like. In use the adjustable stake assembly can be pressed into the ground by stepping on the side projection/top plate 114.

In the embodiment shown, central portion 121 of the stake segment 120 comprises at least one lateral connector section 121 appointed for receiving at least one lateral connector section 121 of another stake segment 120 for cross-wise connection of the stake segments 120 in relation to one another. Preferably, at least two lateral connector sections 121 are provided as shown. Lateral connector sections 121 of central portion 121 are constructed having a major portion 131 abutting a minor portion 132. Minor portion 132 has a smaller size than the major portion 131 forming the lateral connector section 121 so that the sections 121 are formed as notches.

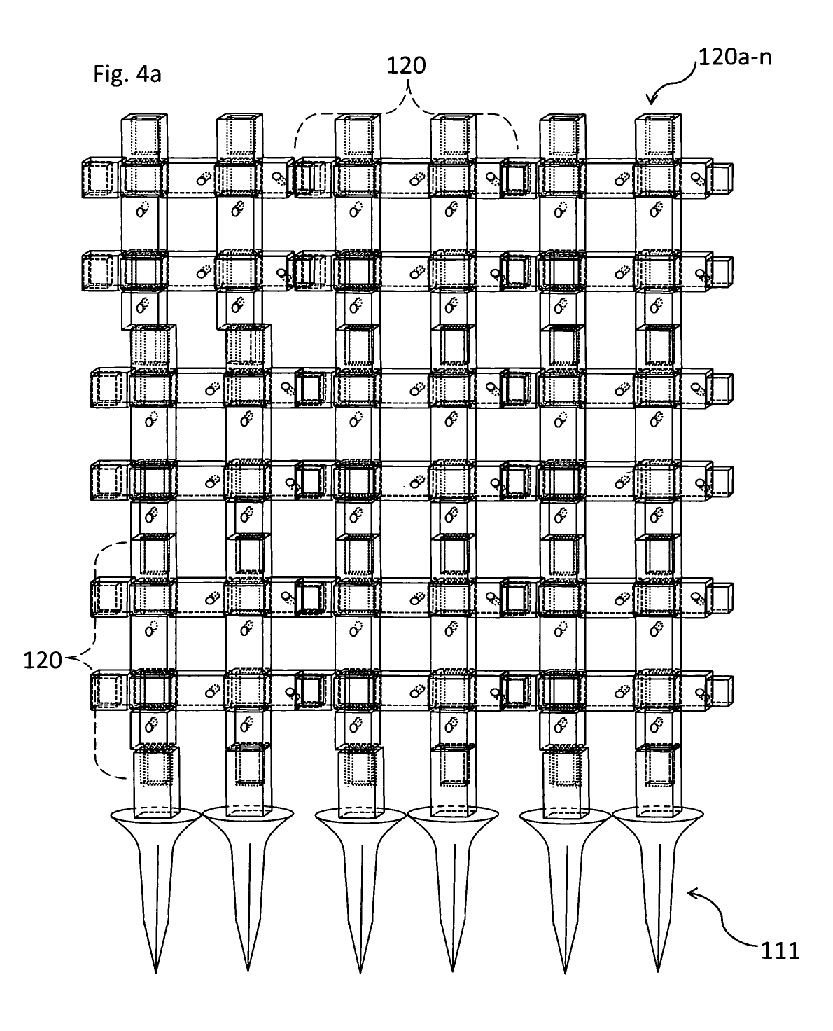

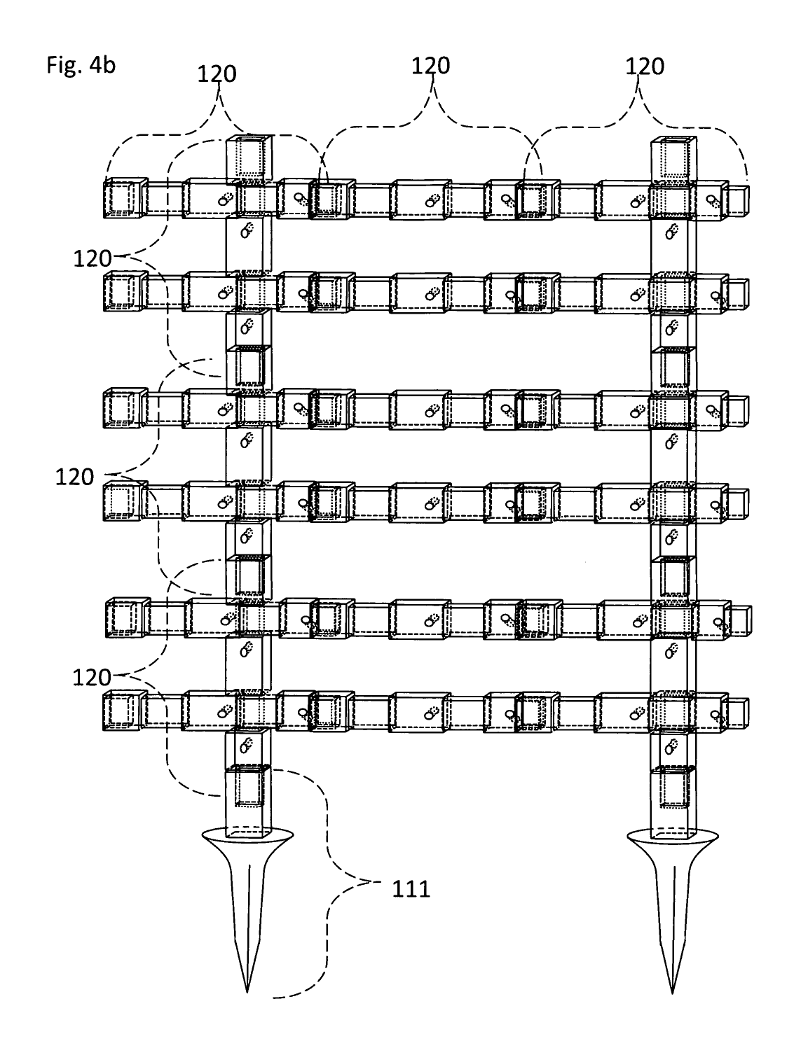

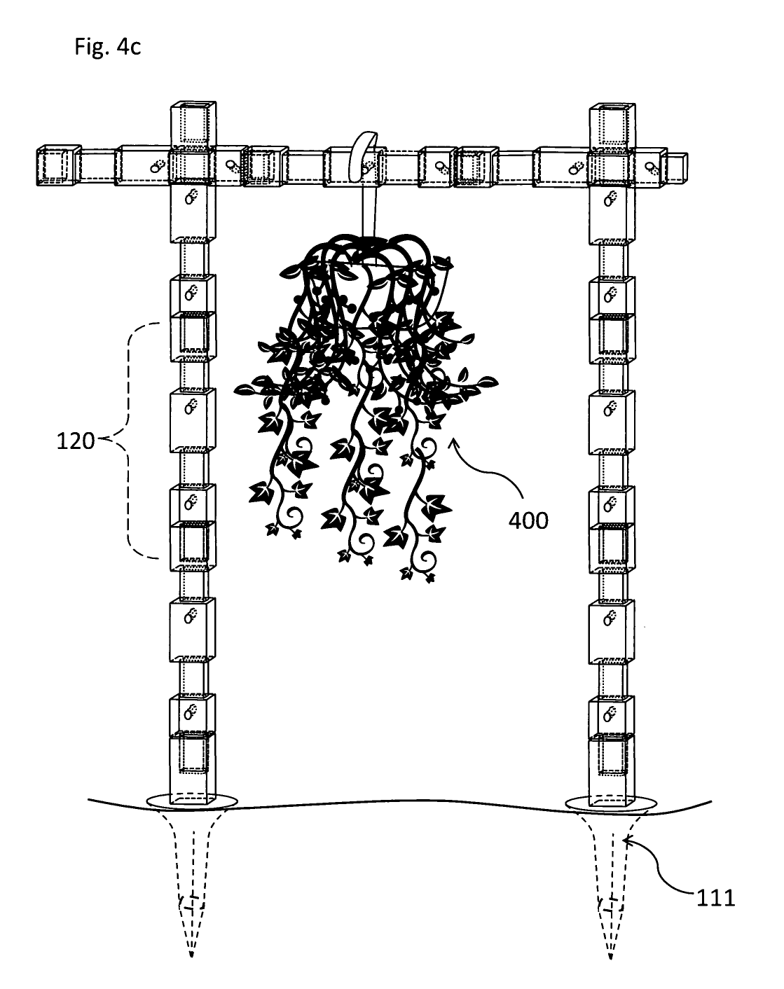

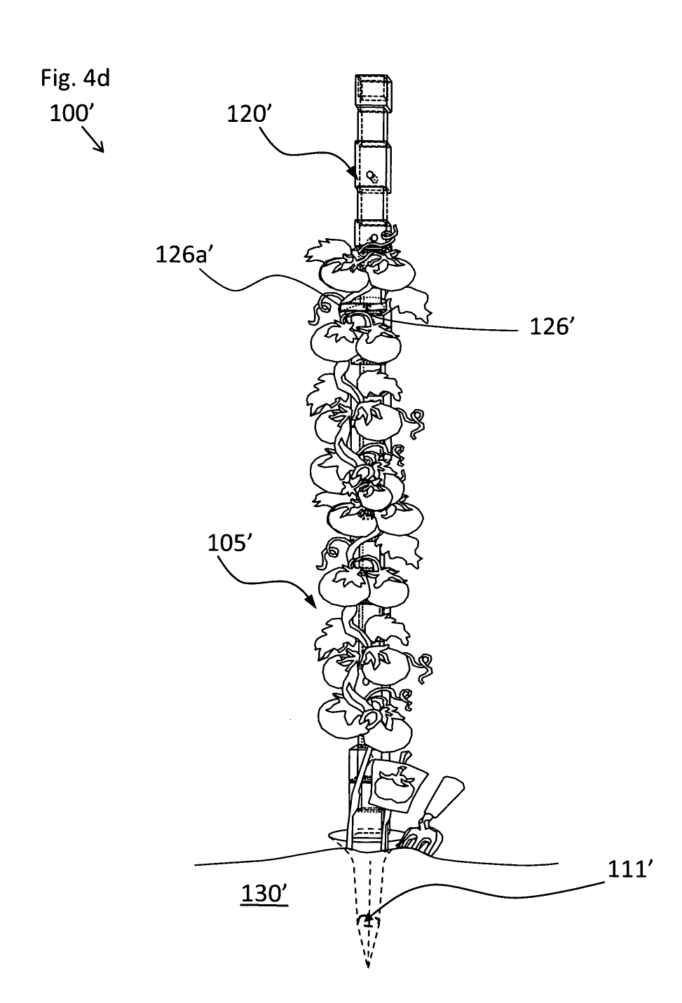

FIGS. 4a and 4d show different configurations of the embodiment of FIG. 3a snapped together to form a fence or lattice structure that may be used for a plethora of operations, including as a plant lattice, fencing around an area, to create a gate type structure, plant holder, or single support structure. Universal stake support 111 with stake segments 120 snapped thereon as discussed in relation to FIG. 3a, 3b is provided. Stake segments 120 are also horizontally cross-wise attached to one another at lateral connector sections 121 to form a fence or gate structure. FIG. 4c is a view of the embodiment of FIG. 3a snapped together to form a lattice structure in another configuration such as for holding hanging baskets 400. FIG. 4d is a view of the embodiment of FIG. 3a showing a single adjustable stake assembly 100′ with the universal stake support 111′ inserted into the ground 130′ and stake segments 120′ stacked height wise as needed depending on the growth of a tomato plant 105′. Ties 126a′ may be utilized by simply wrapping around stake segments 120′ or by way of insertion through support holes/apertures 126′ to tie the tomato plant 105′ to the stake segment 120′.

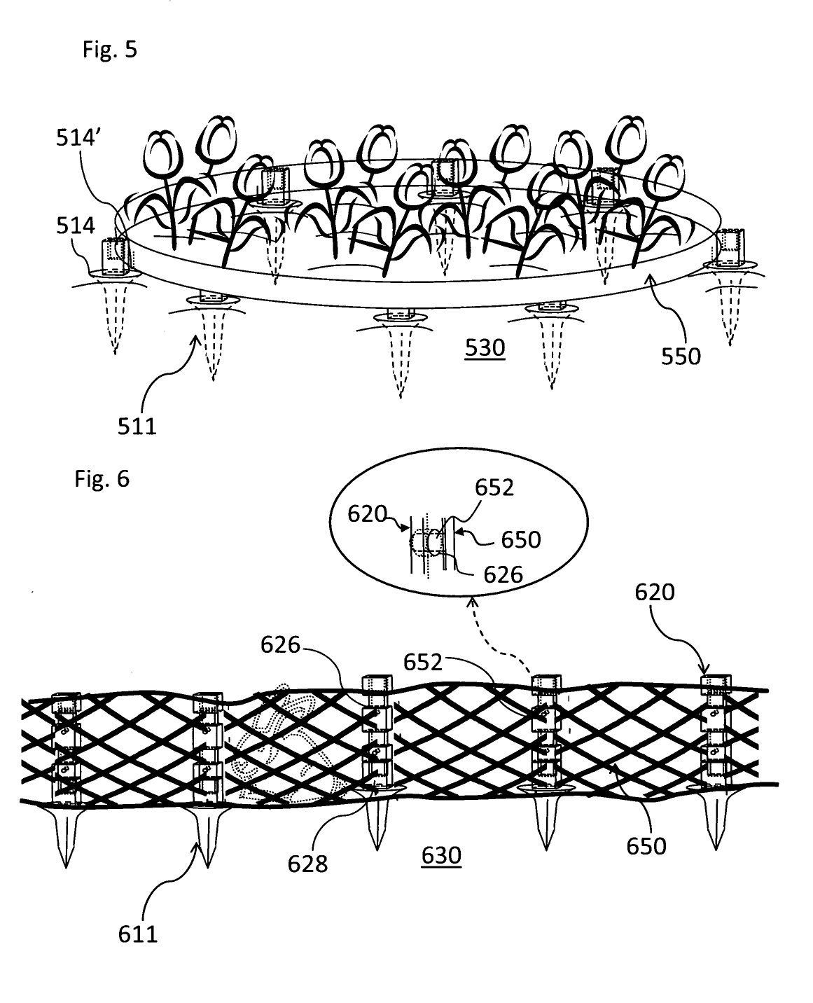

FIG. 5 is a view of the adjustable stake assembly being configured to hold a fence attachment for landscaping plants. Herein universal stake supports 511 are shown staked into the ground 530. Although the universal stake supports 511 do not include stake segments inserted therein, it is to be understood that stake segments can readily be inserted therein if needed for greater height. A landscape boarder or shallow fence 550 is mounted on universal stake supports 511. Mounting of the landscape boarder 550 can be achieved by simply applying pressure from the top plate 514 pressing downward on the boarder 550 so that the boarder is jammed between the ground 530 and the top plate 514. Alternatively, top plate 514 may include a u-shaped lip 514′ that retains boarder 550.

FIG. 6 is a view of the adjustable stake assembly being configured to hold a cross-link fence attachment for keeping pests out of a garden. Herein universal stake supports 611 are shown staked into the ground 630 with stake segments 620 inserted therein; it is to be understood that addition stake segments 620 can readily be inserted therein if needed for greater height. A mesh fence 650 is mounted on the universal stake supports 611 and stake segments 620. Mounting of the mesh fence 650 can be achieved by simply tying the fence 650 to the stake supports 611 and stake segments 620 via rope, string, or zip ties simply wrapped around each of the stake segments 620 or via entry into apertures 626, 628 of the segments 620 and/or universal stake support 611 for securing. In another embodiment, the mesh fence 650 may include snap-knobs 652 that align with and snap into each of the apertures 626, 628 of each of the stake segments 620 and universal stake supports 611.

FIG. 7 is a view of the adjustable stake assembly, universal stake support 711 with stake segments 720, arranged to receive a snap-on plate tray 750 add-on for forming a plant holder, or small table top. Snap-on plate tray 750 includes a flange 754 appointed to be received in the segment aperture 725 of the stake segment 720/or where no stake segments 720 are attached, within stake aperture 716 of universal stake support 711.

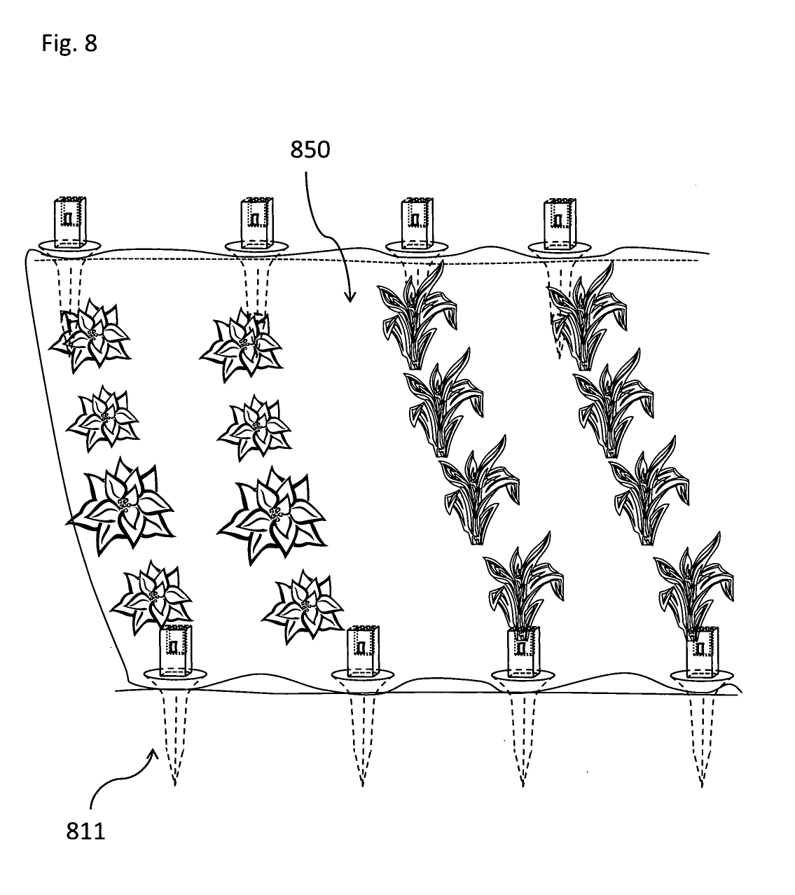

FIG. 8 is a view of the adjustable stake assembly wherein universal stake supports 811 are utilized to hold a tarp or plastic mulch 850. Although the universal stake supports 811 do not include stake segments inserted therein, it is to be understood that stake segments can readily be inserted therein if needed for greater height.

FIG. 9 is a view of the adjustable stake assembly being configured to hold a net attachment for forming a recreational net for volleyball or bad mitten, or the like. In the configuration shown, adjustable stake assembles are constructed having a universal stake support 911 with stake segments 920 snapped thereon forming two pole like structures 900′. Between the two pole-like structures 900′ a net 950 is inserted via attachment to stake segments 920. Attachment may be facilitated in a number of ways. In one embodiment, the net 950 is attached via rope, string, cable zip tie, or the like simply wrapped around each of the stake segments 920. In another embodiment, attachment may be facilitated by attached via rope, string, cable zip tie, or the like simply by inserting same in the apertures 926 of each of the stake segments 920. In yet another embodiment, the net 950 may include snap-knobs 932 that align with and snap into each of the apertures 926 of the stake segments 920. Additional universal stake supports 911′ may be provided wherein a rope 935 extends from the assembly to the universal stake supports 911′ and attached thereto by way of support hole/aperture 928′ for adding support to the structure.

FIG. 10 is a view of the adjustable stake assembly being configured to hold a flag attachment 1050 for forming a flag pole or decorative assembly. Flag attachment 1050 includes a flange 1054 appointed to be received in the stake aperture 1016 of the stake segment 1020. Preferably, the height of the flag pole—i.e. constructed via the universal stake support 1011 and vertically stacked stake segments 1020 is in a manner so that it is at least nine feet high.

Having thus described the invention in rather full detail, it will be understood that such detail need not be strictly adhered to, but that additional changes and modifications may suggest themselves to one skilled in the art, all falling within the scope of the invention as defined by the subjoined claims.

1. An adjustable stake assembly, comprising:
a. a universal stake support having a tip appointed to penetrate a surface, a body portion and a top plate having a protrusion with a stake aperture integrated therein;
b. at least one stake segment having a central portion and a lateral and distal end, said lateral end having a flange appointed to be received in said stake aperture of said universal stake support, and said distal end having a segment aperture integrated therein, and appointed for receiving another stake segment for vertically stacking a plurality of said stake segments;
c. said central portion of said stake segment comprising at least one support hole; and
d. said lateral end of said stake segment including at least one support hole.

2. An adjustable stake assembly as recited by claim 1, wherein said universal stake support includes at least one support hole.

3. An adjustable stake assembly as recited by claim 1, wherein said stake segment includes at least one fastener means.

4. An adjustable stake assembly as recited by claim 1, wherein said universal stake support has 12 to 32 inches in height.

5. An adjustable stake assembly as recited by claim 1, wherein said universal stake support is 24 inches in height.

6. An adjustable stake assembly as recited by claim 1, wherein said top plate of said universal stake support has a diameter ranging from 8 to 12 inches.

7. An adjustable stake assembly as recited by claim 1, wherein said protrusion is located at a center point on said top plate of said universal stake support.

8. An adjustable stake assembly as recited by claim 1, wherein said central portion of said stake segment comprises at least one lateral connector section appointed for receiving at least one lateral connector section of another stake segment for cross-wise connection of said stake segments in relation to one another.

9. An adjustable stake assembly as recited by claim 8, wherein at least two lateral connector sections are provided, each being appointed to receive at least one lateral connector section of two other stake segments for cross-wise lattice connection of said stake segments in relation to one another.

10. An adjustable stake assembly as recited by claim 8, wherein said central portion of said stake segment is constructed having a major portion abutting a minor portion, wherein said minor portion has a smaller size than said major portion forming said lateral connector section.

11. An adjustable stake assembly as recited by claim 10, wherein said central portion of said stake segment is constructed having a major portion abutting two minor portions; wherein said minor portions have a smaller size than said major portion forming at least two said lateral connector sections.

12. (canceled)

13. (canceled)

14. An adjustable stake assembly as recited by claim 1, wherein said adjustable stake assembly is provided as a kit and wherein said adjustable stake assembly kit includes a plurality of said universal stake supports and stake segments.

15. An adjustable stake assembly as recited by claim 1 comprising a lattice fencing structure.

16. An adjustable stake assembly as recited by claim 1 comprising a net.

17. An adjustable stake assembly as recited by claim 1 comprising a fencing portion.

18. An adjustable stake assembly as recited by claim 1 comprising add-on accessories.

19. An adjustable stake assembly as recited by claim 18, wherein said add-on accessories include a snap-on plate tray.

20. A method of using an adjustable stake assembly, comprising the steps of:
a. selecting a universal stake support having a tip appointed to penetrate a surface, a body portion and a top plate having a protrusion with a stake aperture integrated therein;
b. inserting said universal stake support into said surface;
c. attaching at least one stake segment onto said universal stake support, said stake segment having a central portion and a lateral and distal end, said lateral end having a flange appointed to be received in said stake aperture of said universal stake support, and said distal end having a segment aperture integrated therein appointed for receiving another stake segment for vertically stacking a plurality of said stake segments.
